(19) United States
(12) Patent Application Publication
(10) Pub. No.: US 2008/0034592 A1
(43) Pub. Date: Feb. 14, 2008

(54) Razor

(75) Inventors: Brian Douglas Smith, London (GB); Kamlesh Prajapati, Bradford (GB)

Correspondence Address: Thomas E Sisson;Jackson Walker, 112 E Pecan Streeet, Suite 2100, San Antonio, TX, 78205-1521, US

(73) Assignee: FEONIC PLC, LONDON WC1 6AY (GB)

(21) Appl. No.: 11/659,442

(22) PCT Filed: Jul. 29, 2005
(86) PCT No.: PCT/GB05/50122

§ 371 Date: Jun. 1, 2007

(30) Foreign Application Priority Data
Aug. 3, 2004 (GB) 0417231.8

(51) Int. Cl. B26B 21/38

(52) U.S. Cl. 30/45

(57) ABSTRACT

A razor has a thin shaving blade (21) arranged so as to make direct contact with the user's skin, in use, and driver means (24, 25) for vibrating the blade as it is moved in contact with the user's skin. In a preferred embodiment the razor has a thin shaving blade (21) provided with a layer (22) of giant magnetostrictive material on at least a surface thereof and means (24, 25) for applying an oscillating magnetic field to the blade such that the surface of the blade is caused to flutter.

### FIELD OF THE INVENTION

This invention relates to a razor, and in particular to a razor having a vibrating blade or blades.

### BACKGROUND TO THE INVENTION

Razors generally fall into two types: the fixed blade, typically used in conjunction with soap and water or other lubricant and simply drawn across the user's face; and the electric shaver or razor, which typically comprises a thin perforate foil and a blade or blades moving across the rear of the foil as the front is applied to the user's face. In the electric shaver, the blades are usually reciprocated in a linear motion or rotated.

Although some electric shavers can be sealed from ingress of water to permit them to be used in wet conditions, the use of an electric shaver is generally felt to give a less satisfactory shave than the fixed blade wet razor. A “satisfactory shave” pertains to the closeness of cut and comfort of shave. However, the fixed blade razor requires the use of soap or other water/oil based lubricants to give a comfortable shave. A lubricant is also sometimes used with electric shavers to improve comfort level. It is known that even with the sharpest of blades, the hair is often only partially cut by the blade while the remainder being torn or broken by the force of the passing razor head.

It has also been found that a thin layer of giant magnetostrictive material (GMM), when subjected to an oscillating magnetic field undergoes a change in the surface characteristics thereof as the material elongates and contracts locally under the varying magnetic field. The effect causes small-scale “fluttering” of the surface, which has been found to reduce friction during shaving.

### SUMMARY OF THE INVENTION

One aspect of the invention provides a razor having a thin shaving blade arranged so as to make direct contact with the user's skin, in use, the razor including driver means for vibrating the blade as it is moved in contact with the user's skin.

The blade or blades may be caused to vibrate in a direction transverse to the cutting direction and/or in the cutting direction whilst the remainder of the razor remains static, thereby enhancing the cutting action. This has been found to improve the shave considerably as the parts of the razor that are in contact with the skin tend to hold the skin still while the vibrating blade(s) can cut the stabilised hairs more effectively. The amplitude of the vibration of the blade or blades is preferably sufficiently great to ensure that the moving blade completely cuts through the hair. With such a configuration, it has been found that a more comfortable shave can be achieved when used either wet or dry.

The driver means may include a magnetostrictive actuator, driving the blade or blades directly or indirectly, through a mechanical amplifier arrangement to increase the amplitude of the vibrations. Alternatively, the driver means may include a piezoelectric actuator, an electromagnetic actuator, a spring loaded lever linked to a gear mechanism attached to a motor, flywheel or a wind-up mechanism with gear mechanism as for the motor. In any case the razor may be powered from rechargeable batteries that can be recharged via a power cord or inductive means, alkaline batteries, mains power or mechanical wind-up.

It has been found that a low frequency signal works best if it is applied at amplitude not readily achieved by ultrasonic or high frequency oscillations. Preferably the frequency will be in the range of 100-500 Hz, and more preferably from 150-250 Hz, with an amplitude preferably in the range of 20-50 microns. In another embodiment the user will be able to adjust the amplitude and the frequency to suit the hair thickness and density as it has been found that optimised performance is a relationship between frequency and amplitude within the general ranges referred to.

By controlling the frequency, amplitude and direction of the vibrations precisely, it is possible to design a razor that does not tear or break the hair but cleanly cuts through the entire diameter and reduces friction, thereby ensuring a close and comfortable shave.

It will be appreciated that there are many different ways in which a magnetostrictive actuator can be used with a range of mechanical levers to amplify the output signal, these would include lever mechanisms, integrated pivoting scissor actions or mechanical linkages.

In the preferred embodiment the magnetostrictive actuator may comprise a bar of magnetostrictive material, an electromagnetic coil surrounding the bar, a first permanent magnet located at one end of the bar with the south pole thereof directed towards the bar, a second permanent magnet located at the other end of the bar with the north pole thereof directed towards the bar, incompressible spacer means located between each magnet and the bar, said spacer means being of a material of low magnetic permeability, and magnetic circuit means extending from the outwardly-directed pole of the first magnet to the outwardly-directed pole of the second magnet.

With this configuration, it is possible to construct an effective magnetostrictive actuator which has a very small size and weight, for example less than 10 g, and using only a small, and therefore less costly, quantity of magnetostrictive material. For example, a length of less than 15 mm is suitable and preferably less than 10 mm, with a thickness of less than 4 mm and preferably about 2 mm. In a shaving device, such an actuator can still produce sufficient amplitude to permit it to be amplified to the amplitude band indicated herein.

One embodiment of the device of the invention includes a magnetostrictive actuator comprising a bar of magnetostrictive material, an electromagnetic coil surrounding or adjacent to the bar, spring means mechanically loading the bar and at least one permanent magnet biasing the magnetostrictive material such that a modulating electrical signal applied to the coil thereby applying a modulated varying magnetic field to the material produces a substantially proportional modulated change in length of the bar.

GMMs display a relationship between magnetic field applied and elongation which will depend on the load applied. As may be seen from FIG. 1, a series of curves may be drawn representing these relationships under different loads σ₁-σ₅. To ensure maximum displacement in response to a change in magnetic field, one needs to select an operating curve which has a steep gradient, while to minimise distortion to the output, it is necessary to operate within as near a linear part of the curve as possible. By mechanically loading the bar of magnetostrictive material so that the best curve is selected, and by magnetically biasing the material so that the changes in magnetic field due to the modulation on the coil lie within a substantially linear part of that curve, optimum operating conditions are achieved. In the graph, a suitable curve is represented by the loading σ₂, giving a steep gradient resulting in large change of strain for a relatively small variation in magnetic field applied (referred to as a “burst effect”) over a substantially linear part of the curve. It will be understood that the graph is for illustrative purposes only, and is not intended to be an accurate representation of the characteristics of a particular material. Where larger displacements from a given size of GMM are required and efficiency and linearity are not critical, the biasing magnets and spacers can be omitted so that the biasing point is now at the origin and the frequency of the output is also doubled. This embodiment allows for a simpler lower cost and size actuator with fewer components.

It will be appreciated that the term “bar” used herein in relation to magnetostrictive material is intended to include different cross-sections of material, from circular to rectangular; the precise shape will depend on the processes used to divide a manufactured piece of GMM into small “chips” usable in the devices of the invention. These chips may be manufactured from grown rod of magnetostrictive material or by moulding or pressing magnetostrictive material into a dedicated chip of approximately the same dimensions as described above. It is envisaged that the “chip” size in the embodiment shown will be smaller than 15 mm in length and 4 mm in thickness or width, where thickness or width is the maximum dimension of the cross-section of the chip.

In the case of a magnetostrictive active element, for a given force and cross sectional area of the magnetostrictive rod, the length of the actuator may be further reduced by increasing the mechanical amplification used. In order to physically reduce the actuators height, the dimensions of the cross section of the magnetostrictive rod can be altered so that it is no longer square or circular but may be elliptical or rectangular and by using an elliptical or rectangular coil. Further, the force may be increased without increasing the height of the actuator by employing a magnetostrictive rod of greater cross sectional area but maintaining one of the cross sectional dimensions and using an elliptical or rectangular coil with elliptical or rectangular magnetostrictive material. It will be appreciated that separate coils, one on each side of the magnetostrictive element, may also result in a low profile actuator but the amplitude output will be reduced compared with the output of a single coil wound around a single core of material.

As the amplitude of an efficient magnetostrictive actuator as described above is normally 0.1% of linear length it can be seen that to achieve an output amplitude of 20-50 microns from a 15 mm length of magnetostrictive rod will need an amplification of 1.3:1-4.3:1 Whilst it is preferable to reduce the length of the magnetostrictive rod to 10 mm, this increases the amplification range to 2:1-5:1

It can be understood that there are many different ways in which the magnetostrictive output can be amplified including scissor actions, pivot point levers and etc; however it is desirable that the lever is as simple and as efficient as possible with as few moving parts to ensure maximum reliability.

Another aspect of the invention provides a razor having a thin shaving blade provided with a layer of a giant magnetostrictive material on at least one surface thereof and means for applying an oscillating magnetic field to the blade such that the surface of the blade is caused to flutter, thereby reducing friction, in use, between the blade and a user's face.

It is believed that the fluttering of the surface in response to the oscillating magnetic field causes the trapping of a film of air between the blade and the user's face, thereby serving to lubricate passage of the blade across the face.

Preferably, the blade has on at least one surface thereof with a thin film of a GMM, biasing means are provided for biasing the film mechanically and magnetically such that the application of an oscillating magnetic field to the film causes elongation and contraction thereof in at least one planar direction, magnetostriction is volume conserving therefore it must elongate and contract in at least two directions, an electromagnetic coil is located adjacent to the blade, and control means are connected to the coil for applying a high frequency modulating signal thereto, whereby the blade is caused to vibrate at said high frequency.

Where the blade is caused to vibrate, either transversely or along its length, the vibration can be achieved by means of a thin film actuator incorporated into one edge of the blade, either an elongate edge in the case of transverse vibration, or one side edge, in the case of lateral vibration normal to the direction of movement during shaving.

The thin film of GMM may be applied to the blade by sputtering, or other form of deposition for example. The mechanical biasing may be provided by tensioning the substrate during application, and then releasing the tension to compress the film. Alternatively, a plastics coating is applied over the film and then shrunk. Another possibility might be to bend the blade into a curve against the inherent elastic properties of the thin metal, apply the film and then release the bend.

The magnetic biasing of the GMM film may be achieved by applying to the film a further thin film of a magnetic material, again by sputtering, for example, and then magnetising the material. The magnetic material may be iron, or an alloy of iron with magnetic rare earth metals. The thin film magnet may be configured so as to extend along one or both sides of the GMM film element, or at each end of the element with opposed poles, i.e. with a North Pole adjacent to one end of the element and a South Pole adjacent the opposite end of the element. Further unmagnetised ferromagnetic film elements may be provided on the substrate to provide the return magnetic path.

In another alternative embodiment of the invention, a small more conventional magnetostrictive actuator may be located adjacent or in direct connection to the blade and in contact with an edge region thereof such that vibration is induced in the desired direction. For example, if fluttering is desired, the actuator may be arranged with the magnetostrictive element generally normal to the blade surface so as to induce into the blade a standing wave causing the effect of fluttering along the length thereof. If the blade is desired to vibrate in a direction transverse to the cutting movement direction, the actuator may be arranged at one end of the blade and acting on an edge of the blade in the plane of the blade. Finally, if the blade is desired to vibrate in the direction of shaving movement, the actuator may be located at the edge opposite to the cutting edge and again acting in the plane of the blade. Combinations of these arrangements may be used, as well as combinations of separate actuators and thin film actuators forming part of the blade structure to provide the desired combination of blade movements.

### BRIEF DESCRIPTION OF THE DRAWINGS

In the drawings, which illustrate a blade of a razor in accordance with various exemplary embodiments of the invention:

FIG. 1 is a graph showing the variation of strain with applied magnetic field for a typical magnetostrictive material for a range of different biasing forces applied to the material;

FIG. 2 is a cross-section through a small portion of a blade in accordance with one embodiment of the invention, showing the actuating magnetic coils associated therewith;

FIG. 3 is a front elevation of the blade in accordance with another embodiment, showing a separate magnetostrictive actuator associated therewith;

FIG. 4 is a plan view of a blade according to a third embodiment of the invention; and

FIG. 5 is a plan view of a blade according to a fourth embodiment.

FIG. 6 is a cross-sectional diagrammatic view of a magnetostrictive actuator according to a preferred embodiment of the invention with a circlip to hold components within the housing;

FIG. 7 is a cross-sectional diagrammatic view of a magnetostrictive actuator according to a preferred embodiment of the invention with a crimp to hold components within the housing;

FIG. 8 shows a typical mechanical amplifier to produce a 3:1 amplification; and

FIG. 9 shows a typical blade cartridge or cassette.

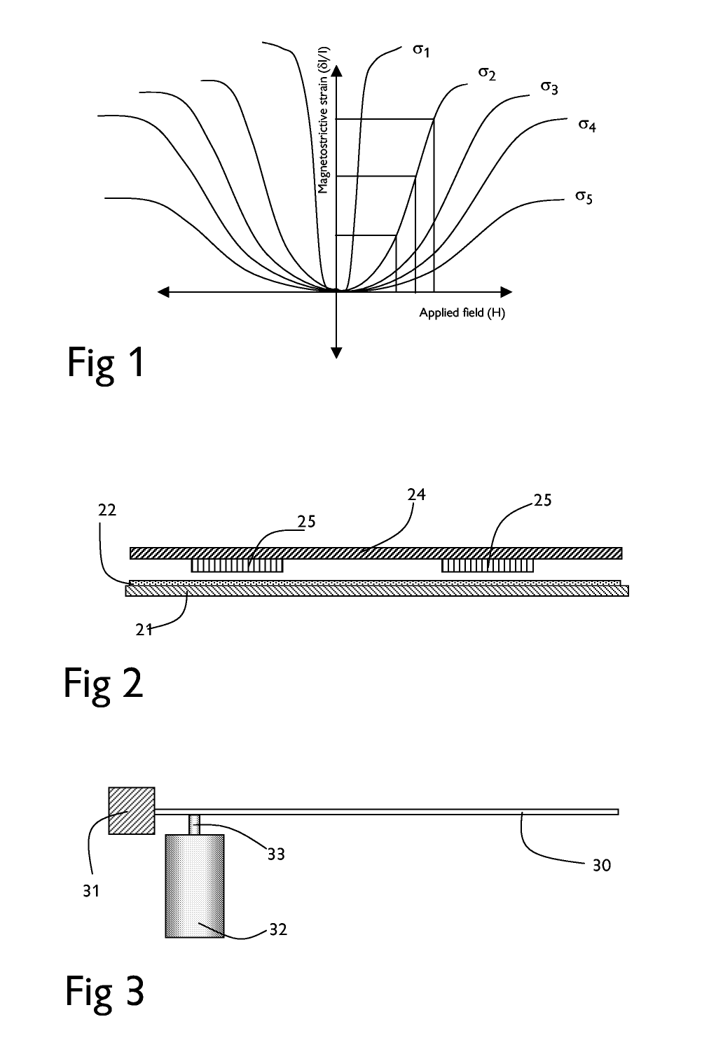

### DETAILED DESCRIPTION OF THE ILLUSTRATED EMBODIMENTS

Referring first to FIG. 2, the blade 21 is provided with a sputtered layer 22 of a giant magnetostrictive material (GMM). A support 24 is mounted adjacent to the blade and carries a plurality of electromagnetic coils 25 connected to a signal source providing an excitation to the coils at a frequency of several kilohertz. This causes the local magnetic domains in the GMM layer on the blade to change shape or flutter at the excitation frequency, which it is believed will cause a reduction in friction between the blade and the user's skin, giving a smoother and more comfortable shave.

Referring now to FIG. 3, an alternative arrangement for causing fluttering of the blade edge is illustrated. The blade 30 is held by mounting means 31 at one end thereof and is free along the remainder of the length. A small magnetostrictive actuator 32 is mounted adjacent to the mounting means 31 with the shaft 33 thereof in contact with the blade so as to induce a standing wave in the blade when an alternating current at a suitable frequency is supplied thereto. The standing wave in the blade at this frequency has the effect of causing the edge of the blade to vibrate, enhancing the shaving action of the razor.

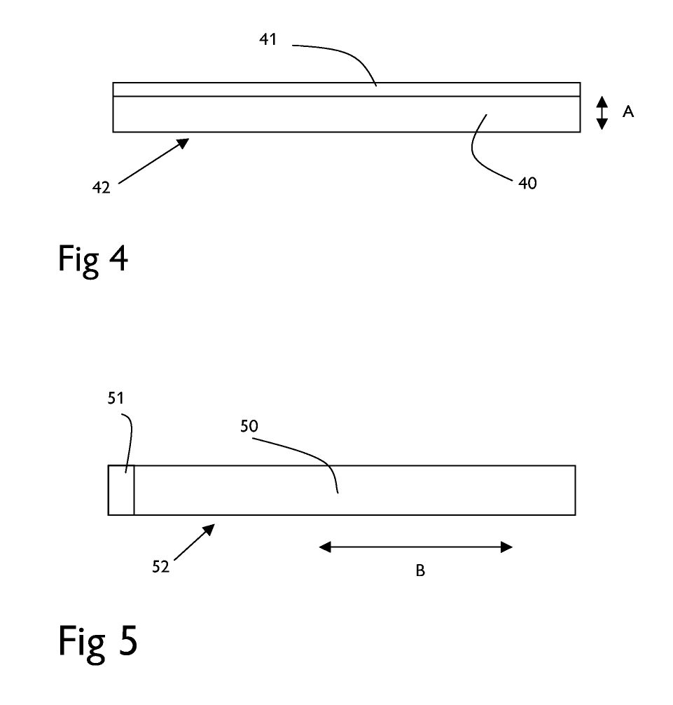

FIG. 4 illustrates an arrangement in which the blade 40 is provided with a thin film strip 41 of GMM along one side thereof, mounted in use between biasing magnets and energising electromagnetic coils which, when supplied with a suitable electrical signal cause alternating elongation and relaxation of the strip 41, in turn causing the leading edge 42 of the blade to advance and retreat in the manner indicated by the double arrow A. It is believed that this reciprocating movement enhances the cutting effect of the blade, giving a closer shave.

In the embodiment illustrated in FIG. 5, the blade 50 has a thin film strip 51 of GMM along one short edge thereof, with associated biasing permanent magnets and energising electromagnets which, when supplied with a suitable electrical signal cause alternating elongation and relaxation of the strip 51, in turn causing the leading edge 52 of the blade to oscillate transversely of the shaving direction, in the manner indicated by the double arrow B. It has been found that an enhancement of the shaving effect of the blade can thus be achieved.

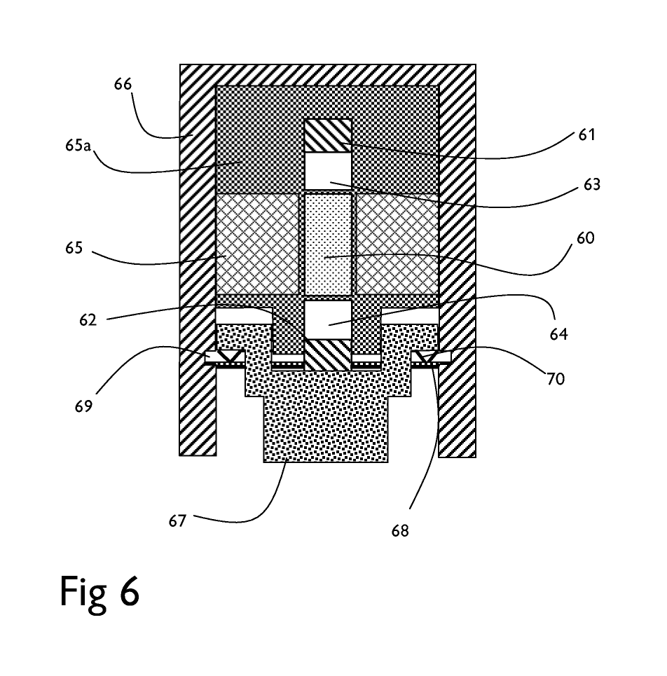

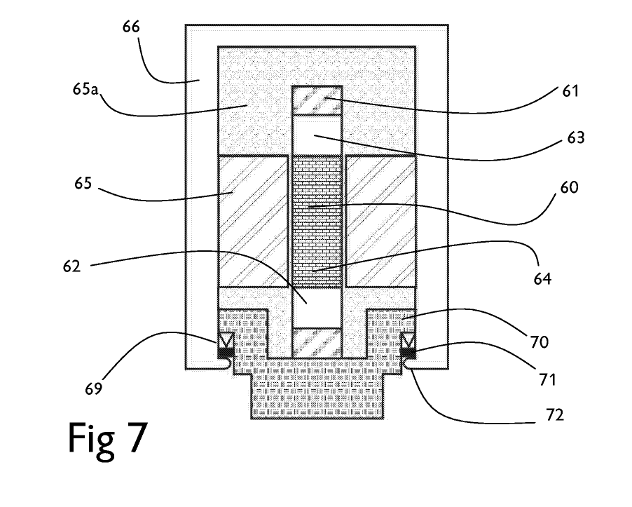

FIG. 6 shows a schematic cross-section through a magnetostrictive actuator in accordance with a preferred embodiment of the invention. A small element 60 of Terfenol-D is mounted between two high-powered button magnets 61 and 62, with spacers 63 and 64, for example ceramic, spacing the poles of the magnets from the ends of the element 60. The magnets are arranged such that one magnet has its north pole directed towards the element 60, while the other magnet has its south pole directed towards the adjacent end of the element. Surrounding the assembly of magnets, spacers and the element is an electromagnetic coil 65 arranged to cause a varying magnetic field to flow axially through the element 60 in response to the application thereto of a modulating signal, which may be a single frequency or an audio source signal such as a tone or noise generating circuit. The electromagnetic coil 65 is wound on a plastics former 65a, which also serves to encase and position the magnets 61 and 62, the spacers 63 and 64 and the element 60. A steel or suitable manufactured metal or magnetic polymer cylinder 66 encloses the coil and provides the outer path of the magnetic circuit through the element 60. One end of the magnet/spacer/element assembly 60-64 carries the weight of the coil 65 and cylinder 66 via the former 65a, while the other end has a pusher cap 67, which is suitably formed of aluminium, steel or a plastics material, bearing against it. The pusher cap 67 is held in position in the cylinder 66 by a steel circlip 68 (shown) which is received in a groove 69 around the inside of the cylinder 66 while a wave spring 70 is mounted between the circlip 68 and the pusher 67 to exert a biasing pressure on the end of the assembly 60-64 sufficient to ensure that the optimum relationship exists between the magnetic field applied and the elongation of the element 60. A typical pressure applied would be of the order of 5-8 MPa. In use, the weight of the coil and cylinder assembly provides a reaction force, so that when the pusher is in direct or indirect contact with the blade drive lever and a signal is applied to the coil, force generated by the element is transmitted directly to the blade drive lever. FIG. 7 shows the same actuator as in FIG. 6 but with an alternative method of holding the core by crimping 72 the housing 66 and replacing the circlip 68 with a washer 71.

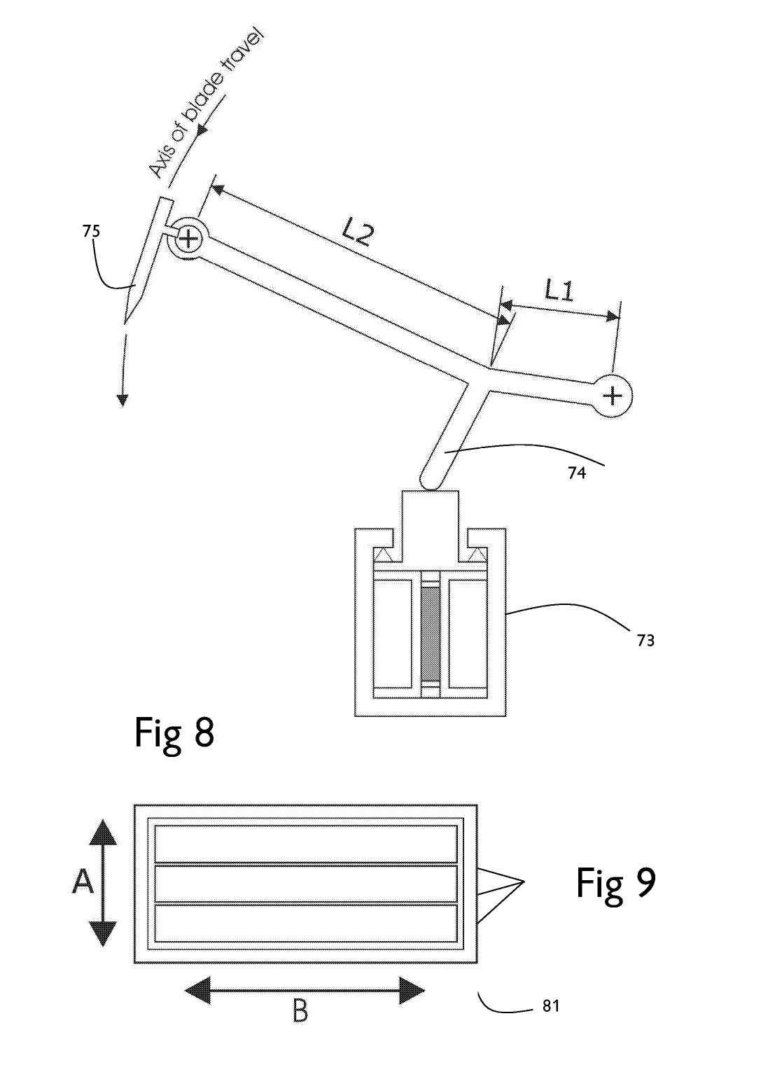

FIG. 8 shows a mechanical amplifier designed to provide at least a 3:1 amplification whilst delivering at a frequency of 100-500 Hz. The magnetostrictive actuator 73 is positioned such that the pusher 67 engages with the blade drive lever 74. The blade drive lever is mounted in such a way as to rotate about a pivot centre in order to transfer all of the available movement through the lever to the blades 75. The length of the elements to the fulcrum where the pusher engages with the blade lever are arranged such that the mechanical leverage falls into the required ratio 2:1 to 5:1 by the relative adjustment of lengths L1 and L2.

FIG. 9 shows a typical blade carrying cartridge or cassette 81 with a multiplicity of blades 80 where the blades move independently in either direction a or direction b without the cartridge or cassette moving with them.

1. A razor having a thin shaving blade arranged so as to make direct contact with the user's skin, in use, the razor including driver means for vibrating the blade as it is moved in contact with the user's skin.

2. A razor according to claim 1, wherein the driver means is arranged to cause vibration of the blade or blades in a direction transverse to the cutting direction.

3. A razor according to claim 1, wherein the driver means is arranged to cause vibration of the blade or blades in the cutting direction thereof.

4. A razor according to claim 1, wherein the driver means is arranged to vibrate the blade at a frequency of 100-500 Hz.

5. A razor according to claim 4, wherein the frequency is 150-250 Hz.

6. A razor according to claim 4, wherein the driver means is arranged to vibrate the blade with an amplitude of 20-50 μm.

7. A razor according to claim 1, wherein the driver means include control means whereby the amplitude and/or frequency of vibration of the blade can be controlled by the user to suit his/her shaving preference.

8. A razor according to claim 1, wherein the driver means includes at least one magnetostrictive actuator associated with the blade.

9. A razor according to claim 1, wherein the driver means includes at least one piezoelectric actuator associated with the blade.

10. A razor according to claim 1, wherein the driver means includes an electromagnetic actuator.

11. A razor according to claim 1, wherein the driver means includes a spring loaded lever linked to a gear mechanism attached to a motor.

12. A razor having a thin shaving blade provided with a layer of a giant magnetostrictive material on at least one surface thereof and driver means for applying an oscillating magnetic field to the blade such that the surface of the blade is caused to flutter, thereby reducing friction, in use, between the blade and a user's face.

13. A razor according to claim 12, wherein the blade is carried in a removable cartridge.

14. A razor according to claim 12, comprising a plurality of blades.

15. A razor according to claim 14, wherein the driver means is arranged to vibrate all the blades at the same time.

16. A razor according to claim 1, comprising a removable cartridge in which the or each blade is mounted.

17. A razor according to claim 16, wherein the driver means is arranged to vibrate all the blades at the same time.
